(19) United States
(12) Patent Application Publication
(10) Pub. No.: US 2013/0195947 A1
(43) Pub. Date: Aug. 1, 2013

(54) BIOCIDE POWDER FORMULATION

(71) Applicant: Willem Anker, Ellerbek (DE)

(72) Inventor: Willem Anker, Ellerbek (DE)

(21) Appl. No.: 13/635,537

(22) PCT Filed: Mar. 17, 2011
(86) PCT No.: PCT/US11/28782

§ 371 Date: Oct. 25, 2012

Related U.S. Application Data
(60) Provisional application No. 61/314,708, filed on Mar. 17, 2010.

(51) Int. Cl. A01N 25/12; A01N 47/12

(52) U.S. Cl. CPC A01N 25/12; A01N 47/12
USPC 424/405; 514/478

(57) ABSTRACT

A storage stable, free flowing powder concentrate for use in the manufacture of a biocide formulation comprises a t biocide containing an iodopropynyl group and an inert filler, wherein the wt % ratio of biocide: inert filler is from about 1:1 to about 1:100 and the wt % of biocide is not more than 50%.

### TECHNICAL FIELD

The present invention relates to a free flowing powder concentrate of biocides, particularly of IPBC, and their incorporation into various compositions useful in varied industrial processes requiring antimicrobial protection. More specifically, the present invention provides a biocide concentrate comprising a biocide containing an iodopropynyl group and an inert filler, wherein the wt. % ratio of biocide: inert filler is from about 1:1 to about 1:100 and the wt. % of biocide is not more than 50%.

The free flowing powder concentrates of biocides of the present invention are easy to handle due to their non-sticky and non-clinging feature and are also storage stable due to minimal moisture content.

The powder concentrates of the present invention are suitable for use in paint, building materials, stucco, concrete, caulks, sealants, joint compounds, adhesives, leather, wood, inks, pigment dispersions, metal working fluids, drilling mud and/or clay slurries done to their anti-biocidal/antimicrobial action.

### BACKGROUND

Most of the industrial biocide formulations used today are formulated with organic solvents that are volatile organic compounds (VOCs). For example, organic solvents such as petroleum distillates, dimethyl sulfoxide (DMSO), glycol ethers, N-methyl pyrrolidone (NMP), and propylene glycol (PG), are commonly used to prepare commercially-available biocide formulations used in the treatment and preservation of paints and coatings, wood, masonry and other industrial applications. These volatile organic compounds contribute to environmental concerns when released into the environment and their use in paints and coatings, in particular, is becoming less desirable.

One of the approaches to address this problem has been to develop aqueous dispersions of poorly soluble biocides, and/or solutions of biocides in low-VOC solvents, e.g., polyethyleneglycol (PEG) and PEG/water. Aqueous dispersions of biocides, however, often suffer from stability problems, and it is also often difficult to effectively and uniformly disperse the biocide in the matrix undergoing treatment. PEG-based biocide solutions provide reduced VOCs, but have higher viscosities which are disadvantageous for handling by the end-user. PEG-based formulations are also limited in terms of active biocide concentration due to the higher viscosity caused by the PEG.

One common biocide is 3-iodo-2-propynyl butyl carbamate (IPBC). IPBC is a well known preservative/antibacterial for use in cosmetic, paint and coating formulations; it can be added readily to such formulations at room temperature. However, IPBC is further associated with a difficulty in its handling in its various industrial applications, because it tends to be clumpy and sticky. More particularly, it cannot be fed easily from blending equipment and automatic feeding devices. Moreover, it is necessary to physically break up clumps of IPBC to provide a good dispersion of the material when processing it into various polymer based industrial applications. Even if chunks of IPBC are pulverized the powders reclump quickly into an undesired form for handling in industrial production of plastic and polymer products. Other biocides are fine and sticky powders, that, upon mixing with other ingredients, cling to the walls of the mixing vessel; accordingly, it is difficult to predetermine their use levels, and it also creates a hazardous clean-up situation.

U.S. Patent Application 20060229381 by ISP INVESTMENTS INC. discloses a matrix which is a polymer, plastic or polymer-wood composite including a composition of a biocide and a processing additive therewith in the form of a free-flowing powder.

U.S. Patent Application 20090258916 by ROHM AND HAAS COMPANY discloses a stable low-melting biocidal composition, and a stable aqueous dispersion of a low-melting, solid biocide. A stable low-melting mixture containing DCOIT and IPBC is disclosed.

Still, there exists a need, therefore, for biocides particularly for IPBC, that are easy to handle and are free from agglomeration and clump formation.

For these reasons, it is an object of this invention to provide a composition containing a biocide, e.g., IPBC, 3-iodopropynyl carbamate (IPC), or 3-iodopropynyl-N-phenyl carbamate (IPPC), and an inert filler, in the form of a storage stable free-flowing powder concentrate.

Further, the powder concentrate of the present invention does not cause feeding problems, and remains free flowing after packaging and storage.

Another advantage of the present invention is the powder concentrate described herein has processing stability at high temperature and alkaline conditions, and exhibits stability in wet storage conditions.

These and other objects and features of the invention will be made apparent from the following description.

### SUMMARY

We have discovered solid free flowing powder concentrates of IPBC, which can be used for various industrial purposes. Such free flowing powder concentrates of biocides are not only easy to handle due to their non-sticky and non-clinging feature but are also storage stable due to minimal moisture content.

In accordance with the present invention, there is provided a storage stable free flowing powder concentrate for use in manufacture of biocide formulations comprising a biocide containing an iodopropynyl group and an inert filler.

More specifically, the present invention provides a biocide powder concentrate comprising a biocide containing an iodopropynyl group and an inert filler, wherein the wt % ratio of biocide: inert filler is from about 1:1 to about 1:100 and the wt % of biocide is not more than 50%.

The biocide containing an iodopropynyl group preferably is selected from iodopropynyl butyl carbamate (IPBC), 3-iodopropynyl carbamate and 3-iodopropynyl-N-phenyl carbamate.

In a preferred embodiment, the biocide is IPBC.

The inert filler is selected from the group consisting of ground natural minerals, ground synthetic minerals, and metal oxides. Preferably the filler is selected from the group consisting of silica, kaolin, gypsum, calcium carbonate, sodium bicarbonate, clays, talc, chalk, quartz, attapulgite, montmorillonite, diatomaceous earth, perlite, zeolite, highly-disperse silica, alumina, titanium dioxide, bentonite, barite, lithopone, mica and silicates alone or in combinations thereof.

In one preferred embodiment of the present, invention the inert filler is a combination of calcium carbonate and silica in wt. % ratio of from about 3:2 to about 15:1.

In one embodiment of the present invention, the maximum particle size of finely divided particles of biocide and the inert carrier is ≦250 μm; and more preferably it is ≦200 μm.

The amount of biocide in the powder concentrate is in the range of about 1 to about 50 wt. % of the total composition; and more preferably in the range of about 10 to 25 wt. %. The amount of inert filler is in the range of about 35 to about 99 wt. %.

The five flowing powder concentrate in a preferred embodiment is formulated in the form of a tablet, powder, flake, particle, or sachet.

In yet another embodiment, the present invention provides a powder concentrate having processing stability at high temperature and alkaline conditions, and exhibiting stability in wet storage conditions.

The storage stable free flowing powder concentrate can be employed in the field of paints, building materials, stucco, concrete, caulks, sealants, joint compounds, adhesives, leather, wood, inks, pigment dispersions, metal working fluids, drilling mud and/or clay slurries, latexes, coatings, mineral slurries, cosmetics, household or personal care formulations, pulp and paper mill samples, wood, leather, and industrial water treatment.

These and other objectives will more readily become apparent from the description and examples which follows.

### DETAILED DESCRIPTION

The invention provides a concentrate formulation for a biocide in an inert carrier. The present concentrate overcomes the shortcomings of prior art systems by providing IPBC concentrates in the form of storage stable free flowing powder concentrate. The composition is stable with regard to agglomeration and crystallization at room temperature.

The biocide formulations of the invention are advantageous in protecting against microbial growth in a variety of industrial applications, and particularly those utilizing high processing temperatures (approx. 80° C. and high) and alkaline conditions. Further, these powders exhibit stability in wet storage conditions. For example, the powder concentrates of IPBC are advantageous for protecting against microbial growth in applications such as paints, building materials, stucco, concrete, caulks, sealants, joint compounds, adhesives, leather, wood, inks, pigment dispersions, metal working fluids, drilling mud and/or clay slurries, latexes, coatings, mineral slurries, cosmetics, household or personal care formulations, pulp and paper mill samples, wood, leather, and industrial water treatment.

The term “storage-stable” used in connection with the present invention refers to the stability of IPBC at high processing temperature (approx. 80° C.); stability in alkaline processing conditions; and in wet storage conditions.

The term “iodopropynyl group” used in connection with the present invention refers to an iodopropynyl group preferably selected from iodopropynyl butyl carbamate (IPBC), 3-iodopropynyl carbamate and 3-iodopropynyl-N-phenyl carbamate. In a preferred embodiment, the biocide is IPBC.

The term “free flowing powder concentrate” used in connection with the present invention refers to powder formulation of IPBC which is stable with regard to agglomeration and crystallization at room temperature and which has free flowability.

The inert filler is selected from the group consisting of ground natural minerals, ground synthetic minerals and metal oxides and preferably is selected from the group consisting of silica, kaolin, gypsum, calcium carbonate, sodium bicarbonate, clays, talc, chalk, quartz, attapulgite, montmorillonite or diatomaceous earth, perlite, zeolite, highly-dispersed silica, alumina, titanium dioxide, bentonite, barite, lithopone, mica and silicates alone or in combinations thereof.

More specifically, the present invention provides a biocide formulation comprising a biocide containing an iodopropynyl group and an inert filler, wherein the wt % ratio of biocide: inert filler is from about 1:1 to about 1:100 and the wt % of biocide is not more than 50%. The inert filler can be present in an amount of 35-99, preferably 40-90 and most preferably 45-85 percent by weight of the total concentrate composition.

The amount of biocide in the powder concentrate is in the range of about 1 to about 50 wt. % of the total composition; and more preferably is in the range of about 10 to 25 wt. %.

Preferred inert fillers include calcium carbonate, kaolin and gypsum.

The calcium carbonate preferably is present in an amount of 35-75, more preferably 40-70 percent by weight of the composition.

The kaolin preferably is present in an amount of 70-90, more preferably 75-85 percent by weight of the composition.

The gypsum preferably is present in an amount of 55-75, more preferably 60-70 percent by weight of the composition.

In preferred embodiments, the concentrate features silica in combination with another inert filler. The silica preferably can be present in amounts of 5-20, more preferably 8-15 percent by weight of the composition.

In one preferred embodiment of the present invention, the inert filler is a combination of calcium carbonate and silica present in a wt. % ratio of from about 3:2 to about 15:1.

In a particularly preferred embodiment, the concentrate features 20-25% IPBC, 60-70% calcium carbonate and 5-15% silica.

In one embodiment of the present invention, the maximum particle size of the finely divided particles of biocide and the inert carrier is ≦250 μm; and more preferably it is ≦200 μm.

The free flowing powder concentrate in a preferred embodiment is formulated in the form of a tablet, powder, flake, particle, or sachet.

In another embodiment, the present invention provides powder concentrates having processing stability at high temperature and alkaline conditions, and exhibiting stability in wet storage conditions. The mixture is free flowing and does not cause feeding problems, and remains free flowing after packaging and storage.

The storage stable free flowing powder concentrate can be employed in the field of paints, building materials, stucco, concrete, caulks, sealants, joint compounds, adhesives, leather, wood, inks, pigment dispersions, metal working fluids, drilling mud and/or clay slurries, latexes, coatings, mineral slurries, cosmetics, household or personal care formulations, pulp and paper mill samples, wood, leather, and industrial water treatment.

The concentrates described herein can be prepared by mixing the individual components using techniques known in the art.

The following examples further illustrate the invention. They are presented to illustrate specific embodiments of the present compositions and methods. These examples should not be interpreted as limitations upon the scope of the invention.

### EXAMPLES

### Concentrates of the Present Invention

| Ingredient | Example 1 | Example 2 | Example 3 | Example 4 |
|---|---|---|---|---|
| IPBC | 24 | 12 | 40 | 24 |
| Calcium carbonate | 66 | — | 45 | |
| Kaolin | — | 80 | — | — |
| Gypsum | — | — | — | 66 |
| Silica | 10 | 8 | 15 | 10 |

These concentrates formed free flowing powders, free of agglomerates and clumps, and exhibited processing stability at high temperatures and alkaline conditions.

This invention has been described in detail with particular reference to preferred embodiments thereof, but it will be understood that variations and modifications can be effected within the spirit and scope of the invention.

We claim:

1. A storage stable free flowing powder concentrate for use in the manufacture of a biocide formulation, said concentrate comprising a biocide containing an iodopropynyl group and an inert filler, wherein the wt. % ratio of biocide: inert filler is from about 1:1 to about 1:100 and the wt. % of biocide is not more than 50%.

2. The free flowing powder concentrate according to claim 1, wherein the biocide containing an iodopropynyl group is selected from iodopropynyl butyl carbamate (IPBC), 3-iodopropynyl carbamate and 3-iodopropynyl-N-phenyl carbamate.

3. The free flowing powder concentrate according to claim 2, wherein said biocide is IPBC.

4. The free flowing powder concentrate according to claim 1, wherein the inert filler is selected from the group consisting of ground natural minerals, ground synthetic minerals, metal oxides, silica, kaolin, gypsum, calcium carbonate, sodium bicarbonate, clays, talc, chalk, quartz, attapulgite, rnontmorillonite, diatomaceous earth, perlite, zeolite, highly-dispersed silica, alumina, titanium dioxide, bentonite, barite, lithopone, mica and silicates, alone or in combinations thereof.

5. The free flowing powder concentrate according to claim 4, wherein said inert filler is a combination of calcium carbonate and silica in a wt. % ratio of from about 3:2 to about 15:1.

6. The free flowing powder concentrate according to claim 1, wherein the maximum particle size of finely divided particles of biocide and the inert canier is ≦250 μm.

7. The free flowing powder concentrate according to claim 1, wherein the amount of biocide is in the range of about 1 to about 50 wt % of the total composition.

8. The free flowing powder concentrate according to claim 1, wherein the amount of inert filler is in the range of about 35 to about 99 wt %.

9. The free flowing powder concentrate according to claim 1, wherein the powder concentrate is formulated in the form of a tablet, powder, flake, particle, or sachet.

10. The storage stable free flowing powder concentrate according to claim 1 employed in the field of paint, building materials, stucco, concrete, caulks, sealants, joint compounds, adhesives, leather, wood, inks, pigment dispersions, metal working fluids, drilling mud and/or clay slurries, latexes, coatings, mineral slurries, cosmetics, household or personal care formulations, pulp and paper mill samples, wood, leather, and industrial water treatment.
